(19) United States
(12) Patent Application Publication
(10) Pub. No.: US 2009/0103687 A1
(43) Pub. Date: Apr. 23, 2009

(54) GEOGRAPHIC REFERENCED TELEPHONE SWITCHING

(75) Inventor: Richard A. Peters, Grapevine, TX (US)

Correspondence Address: FULBRIGHT & JAWORSKI L.L.P, 2200 ROSS AVENUE, SUITE 2800, DALLAS, TX, 75201-2784, US

(73) Assignee: VIXXI Solutions, Inc., Irving, TX (US)

(21) Appl. No.: 11/969,147

(22) Filed: Jan. 3, 2008

Related U.S. Application Data
(60) Provisional application No. 60/980,697, filed on Oct. 17, 2007.

(51) Int. Cl. H04M 11/04

(52) U.S. Cl. 379/45

(57) ABSTRACT

The present invention is directed generally to geographic referenced telephone switching. Geospatial (e.g., XY or XYZ) coordinates are created in order to route 911 emergency telephone calls based on the caller's location in relation to the proper emergency service provider. Essentially the router gathers and verifies customer user information, matches transmission formats with telephone company provided equipment for 911 Public Safety Answering Points (PSAPs), routes calls based on their existing location, and terminates the phone call in the PSAP with the proper ANI (Automatic Number Identification) and ALI (Automatic Location Information) provided. In addition, due to the capabilities of the geographic referenced system, in certain embodiments, the movement of emergency service needs can be anticipated (or predicted) and PSAPs may be conferenced together so that they can respond as a single unit to someone who may be traveling.

### CROSS-REFERENCE TO RELATED APPLICATIONS

The present application claims priority to U.S. Provisional Patent Application Ser. No. 60/980,697 titled “GEOGRAPHIC REFERENCED TELEPHONE SWITCHING,” filed Oct. 17, 2007, the disclosure of which is hereby incorporated herein by reference.

### TECHNICAL FIELD

The following discussion relates generally to telephone switching, particularly telephone switching for emergency calls such as 911 calls, and relates more specifically to a geographic referenced telephone switching system and method.

### BACKGROUND OF THE INVENTION

A problem with traditional Enhanced 911 (or “E911”) telephone switching is that the geographical boundaries of rate centers and wire centers do not match the political boundaries of the service areas. In order to accommodate those political boundaries, the telephone companies have developed a switch that is called a selective router. The selective router manually ties automatic number identification (ANI) or telephone numbers to a particular trunk group. Because of the limitations of the tandem office and the central offices that are connected to the selective router, the selective router cannot accept area codes and prefixes that are outside of the wire centers that it is switching for.

Political boundaries matching central office and wire centers boundaries are absolutely critical because it is important that the proper emergency responder show up at the address of the person who needs help. So if a person were calling from a city, let's say City Y, and their responder resides in City Y, but the central office boundary only covers a portion of City Y, then the people that were not within that boundary would not get the appropriate response. Therefore, the selective router was designed.

This system worked fairly efficiently until telephone end users were allowed to transport their telephone numbers outside of the geographic area of their central office servings boundaries either through Voice-Over-IP (VOIP) or through local number portability or through cellular services, as examples. Once the actual telephone number could not be tied to a direct trunk group that was tied to a service responder, there were a tremendous amount of areas that show up in the database all the way from phone calls not being completed at all, to dispatching responders great distances when they didn't have to be dispatched. Therefore, the local number portability, the nomadic user of VOIP, and the ability to use cellular phones anywhere in the nation creates a crisis in switching systems for the telephone companies and for the 911 responders.

In 1998, the FCC passed what they called Wireless Phase I and Phase IT. Wireless Phase I and Phase II were requirements for cellular providers to switch the 911 calls to Public Safety Answering Points (PSAPs). In Phase I, the wireless provider was only required to switch the call to the PSAP that was closest to the antenna that picked up the cellular call. Almost all of the cellular companies now can switch Phase I calls with a very low error rate of around 20%. In Phase IT, the cellular provider was required to give an XY coordinate destination of the telephone call within 150 feet. At this current time, there is no cellular providers that can meet this requirement. Once Global Positioning System (GPS) handsets become online or when some other triangulation technology such as AOA or GDOA become more refined, it may be possible to meet that requirement. Consequently, currently cellular companies merely switch 911 calls to the appropriate PSAP for the cellular towers that the picked up the call. Recall that in Phase I they just switched to a PSAP that was closest to the antenna that picked up the cellular call, and now they are trying to switch to the appropriate PSAP. According to the National Emergency Number Association, while Phase II is implemented in about 20% of the NFL cities at this point and time, there are no providers that can switch to the appropriate PSAP without having some intermediary answer the call and transfer the call to the right PSAP.

The FCC came out with a Notice of Proposed Rulemaking that went into effect on Jan. 1, 2006. They required VOIP providers to access the current PSAP over the telephone switch network if the VOIP providers “touch” the puiblic-switchled network. VOIP providers who do not touch the public-switched network are not required to provide this access. So, with the problems that face the industry as far as selective routing and connecting calls were concerned, it would seem appropriate for a new and better type of switching environment to be developed.

### BRIEF SUMMARY OF THE INVENTION

The present invention is directed generally to geographic referenced telephone switching. According to one embodiment, geographic (e.g., XY or XYZ) coordinates are created in order to route 911 emergency telephone calls based on the caller's location in relation to the proper emergency service provider. Essentially the router gathers and verifies customer user information, matches transmission formats with telephone company provided equipment for 911 PSAPs, routes calls based on their existing location (whether that is generated by address or by cellular network XY coordination generation, etc.) and terminates the phone call in the PSAP with the proper ANI (Automatic Number Identification) and ALI (Automatic Location Information) provided. In addition, due to the capabilities of the geographic referenced system, in certain embodiments, the movement of emergency service needs can be anticipated (or predicted) and PSAPs may be conferenced together so that they can respond as a single unit to someone who may be traveling toward a new jurisdiction.

Essentially, one embodiment of the present invention uses a Geospatial reference for routing telephone calls instead of using a one-on-one telephone number to trunk number destination for routing telephone calls. It has several advantages over the traditional system. An advantage of one embodiment is that it allows any MPA or MXX to be routed through any office so that numbers that are LNP in service can move to any part of the country. It accommodates nomadic VOIP users by generating an XY coordinate for switching their services to the appropriate provider and it uses the XY coordinate (such as that developed in Phase IT Wireless) to switch cellular customers to the appropriate provider. It does this very quickly, and it allows for immediate changes to the routing system without having to change telephone numbers and end trunk ties. This is done through changing boundary lines in the Geospatial router, something that can be accomplished in a few seconds instead of the weeks that it takes to change telephone numbers. According to one embodiment of the present invention, the Master Street Address Guide which contains the emergency service number boundary is matched to the recorded address in one system instead of having to generate a separate system outside of the selective router, and it verifies the automatic location identification for the provider before a telephone number or DID is issued into the database system. Additionally, certain embodiments combine the automatic location identification (ALI) database into the routing service so that a separate database is not needed to derive the customer's address in the PSAP.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the inventions both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows a block diagram of a geographic referenced switching system according to one embodiment of the present invention;

FIG. 2 shows a block diagram of one embodiment of an ANI block of the system of FIG. 1;

FIG. 3 shows a block diagram of one embodiment of a user input block of the system of FIG. 1;

FIG. 4 shows a block diagram of one embodiment of a geospatial coordinate generator block of the system of FIG. 1;

FIG. 5 shows a block diagram of one embodiment of an MSAG comparator of the system of FIG. 1;

FIG. 6 shows a block diagram of one embodiment of an ID Matcher of the system of FIG. 1;

FIG. 7 shows a block diagram of one embodiment of an ALI format comparator of the system of FIG. 1; and

FIG. 8 shows a block diagram of one embodiment of a call completion block of the system of FIG. 1.

### DETAILED DESCRIPTION OF THE INVENTION

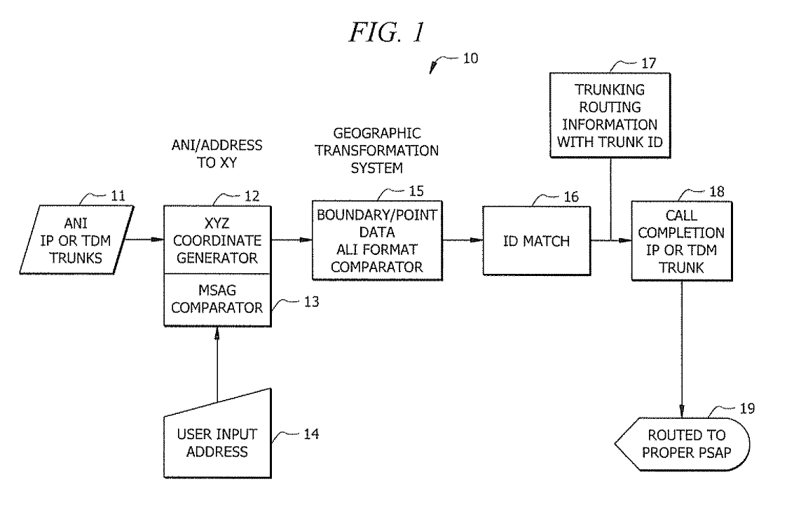

Turning to FIG. 1, a geographic reference telephone switching system 10 according to one embodiment of the invention is shown. System 10 has essentially two inputs. It has a pre-implementation input 14 and it has a post-implementation input 11. The pre-implementation input 14 is an interface that is presented to an end user or telephone user for registering with (or setting up) the system. Input block 14 may present the user with a screen that asks them to provide their address before service is given to them. In other words, before a telephone number would be given to them. The user uses the input screen to input their address. The address is then sent to a Master Street Address Guide (MSAG) Comparator 13, which compares the community's list of valid addresses and emergency service number zones or ESNs or ESZs, as they are often referred to, against the address that the user input in order to make sure that that is a valid service address. If it is not a valid service address, an area code is reported back to the user interface 14, and the user is given a choice of valid addresses to enter. For instance, if the user put in 125 Main Street and the MSAG comparator 13 only had records for 125 North and South Main Streets, the comparator would return this information to the interface 14 to ask the user do you live on North or South Main Street. The user might then indicate it was North Main Street.

Once valid, the address input to interface 14 passes through the comparator 13 to a geospatial coordinate (e.g. XYZ coordinate) generator 12, and a record is generated that shows the user's name, the user's address, the user's telephone number, the user's emergency service number zone, and is tied to a geospatial (e.g., XY or XYZ) coordinate. At that time, that information is then stored into the ALI database 15, and the user's information is formatted for that particular PSAP's end user equipment. There are approximately 37 different ALI formats in use in the United States for PSAP equipment. According to one embodiment, system 10 is implemented to be aware of and reformat its data to match the output for every one of those different formats, which is performed by the ALI format comparator 15. Also, in ALI format comparator block 15 is contained the PSAP boundary files and emergency service number file in a Geospatial format made for query later on.

The second type of input is the post-implementation input, which is an actual emergency call that would arise at telephone switch 10. The call arrives at ANI block 11 in any of several formats; one call might arrive through IP, or what is called a SIP-to-SIP in byte, as an example. The received call format is decoded in ANT block 11, and it is passed to the geospatial coordinate generator 12, which looks up the ANI of the telephone number and then produces the corresponding geospatial (e.g., XY or XYZ) coordinate. The geospatial coordinate is then matched in ALI format comparator block 15 against the boundary and point data file. ID match 16 provides a trunk group. Trunk routing information in block 17 is matched with the trunk ID, and in call completion block 18, the call is completed through IP or TDM or SS7. The same process would be followed if a TDM trunk were hooked to the system and SS7 trunk were hooked to the system or any kind of standard telephony interface were hooked to the system to deliver ANI to telephone switch 10.

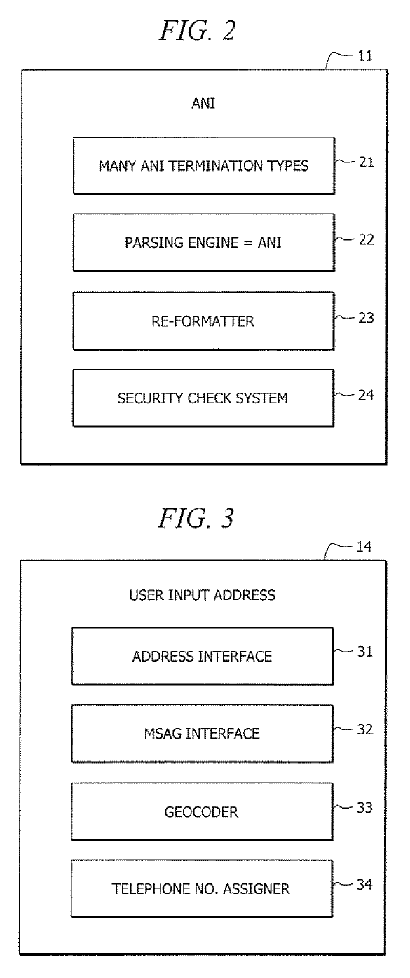

Turning to FIG. 2, a block diagram of one embodiment of an ANI block 11 of the system 10 of FIG. 1 is shown. After this concept was initially conceived of, there were several different things that the inventor discovered that was desirable to add to the environment in order to make it actually work as intended. A desire was recognized to implement block 11, meaning any receptor, to accommodate all the different types of trunk inputs that are possible. Thus, the inventor recognized the desire to be able to accommodate T′M trunks, SS7 trunks, DS0 trunks, Feature Group D trunks, CAMA Trunks, PRI and BRI trunking, etc. Having established those inputs, not only did the inventor discover the solution of adding in a sub-block 21 for determining which type of ANI was being received from which type of trunk, but the inventor also discovered the solution for implementing sub-block 22 to parse the ANT data out from the data stream depending on the trunk type that was being received. Also, the inventor implemented sub-block 23, which formats the ANI so that a comparison could be performed in the ALI address generator comparator 13 and ship that information off and the inventor found the solution to add a very stringent set of security rules 24 so that people who were not customers could not spoof the system and get 911 calls associated with the system. So, the inventor developed a solution to accommodate approximately 8 different types or ANI formats in order to do that.

FIG. 3 shows a block diagram of one embodiment of user input block 14 of the system 10 of FIG. 1. The user input is a source code that allows the customer to create an interface 31, such as a GUI (Graphical User Interface), that identifies the address. A MSAG interface 32 helps store the identified address in a MSAG format that can be transmitted to the MSAG comparator 13, and so the address is reformatted and sent to the MSAG comparator 13 (e.g., via interface 32). A Geocoder input 33 places it into the Geocoder and requests the verification through the Geocoder. Sub-block 34 takes the telephone numbers gathers it when the address is verified, and puts it into the customer database record. The user input block 14 of FIG. 3 is also utilized when the customer changes the location of their phone. The vendor usually notices a DNS or a MAC address change from the customer and then disables their service until a new address is entered or verified for emergency response purposes.

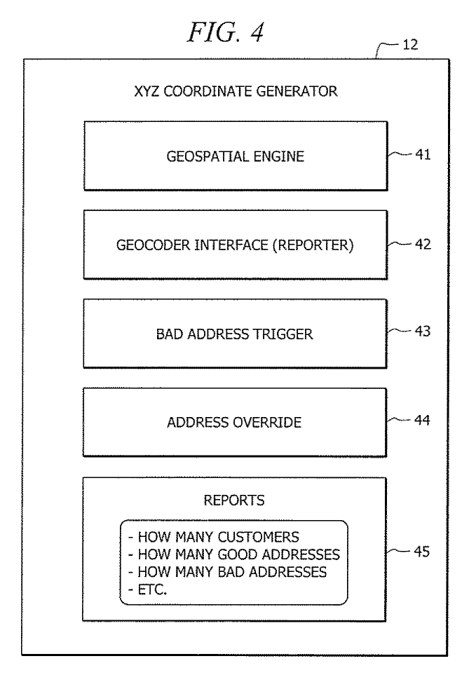

FIG. 4 shows a block diagram of one embodiment of a geospatial coordinate generator 12 of the system 10 of FIG. 1. The geospatial coordinate generator 12 for generating a geospatial coordinate from ANI/ALI information include a geospatial engine 41 which actually looks the address up and creates the geospatial coordinate. A Geocoder 42 actually places the address in the right location, and it also has a reporting engine that tells the GUI how well that placement was made, whether it's a match or it is not a match. If it is a match, it indicates whether it only matches as to zip code or it matches to the street name, or to the address arranged, or to the actual physical address, etc. All of those conditions are reported back to the client so they can determine whether to query the customer for a better address or not. It also has a bad address trigger 43 that allows the user interface to receive several addresses as trial addresses to query the customer and say—well, we couldn't find anything like your address on the database, could it be this, that, or the other address? Bad address trigger 43 actually interfaces with the MSAG comparator 13 so that the address will come up in the correct MSAG format. Then, there is an address override 44. Sometimes addresses go into service before the community creates an MSAG chain when it is verified that it is a legitimate address and it is not in the MSAG, where the override 44 may be used to place the customer record into the database A report Generator 45 is also included, which tells the customer how many good address they had, how many customers they had, how many customers had bad addresses, etc.

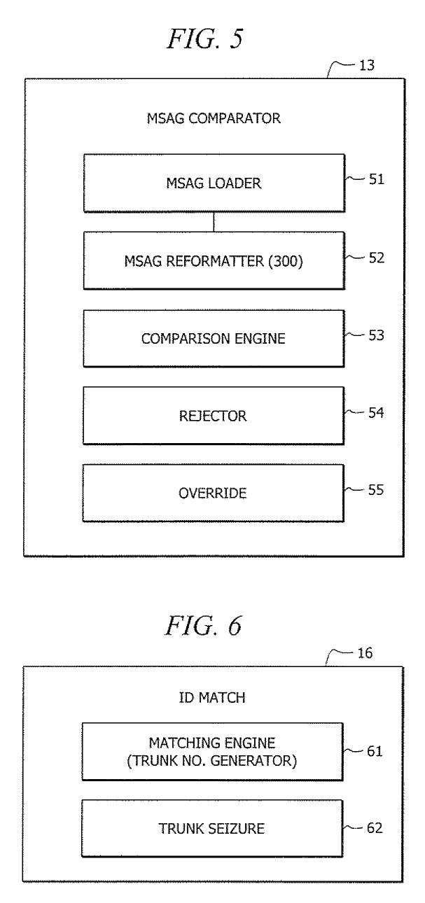

FIG. 5 shows a block diagram of one embodiment of MSAG comparator 13 of the system 10 of FIG. 1. In this exemplary embodiment, the inventor made several changes to the MSAG comparator 13 since the inventor discovered that the MSAG had over 300 different formats and there were over 37 different formats of the ALI information that had to be reported back to PSAPs. So, the inventor added in first an MSAG loader 51 that would take that information from the various jurisdictions and put it into the database. Additionally, a reformatter 52 is included that changes the format of the MSAG so that it is readable by the customer user interface and by the ALI database and Geocoder. Also, a comparison engine 53 is included that outputs whether the address was actually inside of the MSAG. If it was not, then it provides clues as to how to prompt the customer for a legitimate address such as missing suffix, missing prefix, bad address range, things of that nature. Additionally, a rejector 54 is included that flags the user interface to inform the user that this is not a correct address, and also an override feature 55 is included in case a legitimate address is received that is not yet in the MSAG.

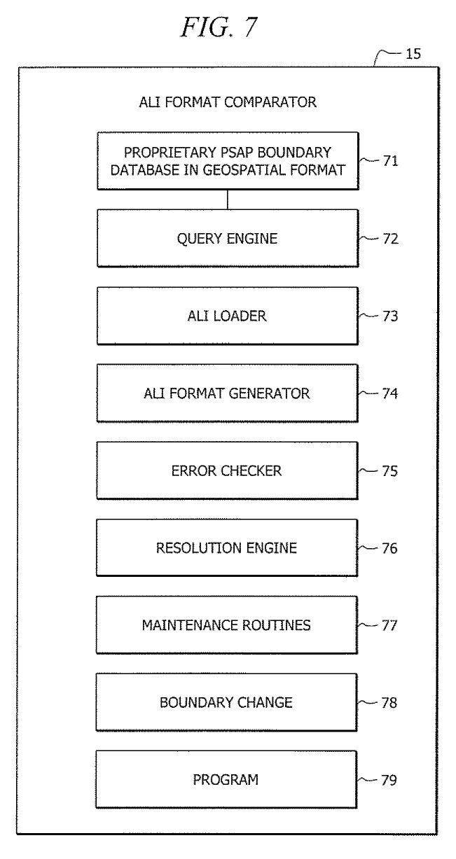

FIG. 6 shows a block diagram of one embodiment of ID match block 16 of the system 10 of FIG. 1. In this exemplary embodiment, the inventor reconfigured the matching engine and trunk generator 61. Based on the new PSAP numbers, which are generated by block 15 of FIG. 7 discussed below, the matching engine 61 brought out the new emergency service provider destination and matched that to a trunk group. Also included in ID match block 16 is a seizure engine 62 for seizing the correct trunk group by routing group number. In block 16, the system resolves the conflict between PSAP IDs and trunk groups, and did the correct PSAP routing configurator.

FIG. 7 shows a block diagram of one embodiment of ALI format comparator 15 of the system 10 of FIG. 1. The inventor has developed a proprietary PSAP boundary database 17 in the geospatial format, which has been owed as a proprietary PSAP boundary database for approximately 1.5 years. The inventor put that proprietary database 71 into the geospatial router 10 so that the system could determine the proper destination code. However, the inventor had to reformat the database in order to match the ESN boundaries that were being supplied to us by the PSAPs. Those ESN boundaries were not in the original database and the data owners had not anticipated their arrival. There is a query engine 72 that is part of the geospatial engine that queries the point and polygon query. There is also an automatic location identification (ALI) loader 73 which loads all of the address information once it is generated and verified as a correct address, and an ALI format generator 74 is included which changes the address information to match the format of the individual PSAP (which was another thing that the database owners did not anticipate would be needed, but there were a considerable number of different types of PSAPs and different types of transmission generation). The system also includes an error checker 75 that cheeks that the formats are matched. Where the ALI information is transmitted, a resolution engine 76 looks for errors and resolves any errors before transmission and if required brings up a human interface. Several maintenance routines 77 for putting in new ALI information and especially taking out old or changed information that had to be done because of the changes the inventor had to make to block 14, the user input when they moved and made their systems nomadic. Also, a boundary change function 78 was added that allowed the system to remove and add boundaries into the original database while it was in operation so that emergency backup determination could be made. An emergency backup system was not anticipated, so the inventor had to add a backup routing system. The backup routing system was based on both jurisdiction and tendered phone number which was gathered by the proprietary PSAP database, but then the inventor had to reformat it so that the tendered number was dialed instead of the trunk routing program being followed if there were failure in the trunks completion of the call. And then, there were various programs 79 written to manage the boundary changes and report them back to the PSAPs.

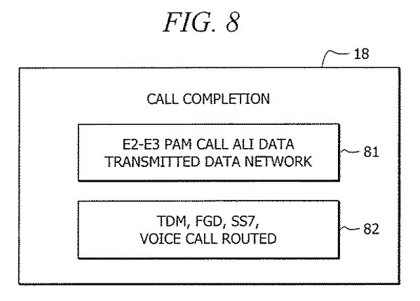

FIG. 8 shows a block diagram of one embodiment of call completion block 18 of the system 10 of FIG. 1. In this embodiment, the inventor discovered that the system had to use the same number of trunk outputs as it had inputs. In other words, the system had to accommodate (in sub-block 82) TDMS, SSI, DS0, Feature Group D, CAMA, PRI, IP and BRI. In addition to the voice side of the call, the system also had to accommodate the data site of the call. According to the regulation, it was supposed to be all 12 compatible. The inventor found out that none of the network, was 12 compatible or E2 compatible, or E3 compatible or I3 compatible for that matter, but a lot of the companies were using old ASCII codes such as PAM, PAM2, Pre-PAM, Pre-I2 and Pre-I3, etc., and so the inventor had to develop those protocols and put them into the call completion router so that things would go to the PSAP correctly and in a format that they could read, in sub-block 81. An additional requirement on the system that is being accommodated is that it will now use 711 routing based on the MPRM that the FCC issued on October 14^{th} that requires all VOIP providers to recognize 711 dialing and route calling to the appropriate deaf center with the appropriate protocols to activate a 400 BAUD TDD device. The inventor built in this protocol into the system and created the 711 database so that the appropriate routing can be done on that.

While this router 10 has been discussed in the context of emergency routing for 911, there are dozens of applications based on location, such as advertising, 411, closest restaurant, and hundreds of other applications with this kind of a geospatial reference-based switch 10 instead of a trunk tied switch. The primary underlying technology allows calls to be routed without human intervention based on location, which is the fundamental concept of the present invention.

According to certain embodiments, pre-registration of several different locations is supported by switch 10 so that a user can take from a list the location that if they have, for instance, two permanent residences or a place they visit quite often without having to reenter the address into the system. Another feature that is implemented in certain embodiments is a voice prompt change, which may be based on the aforementioned monitoring of the DNS and MAC address. Should those two things change, the system will prompt the user and say—we've noticed that you've moved your phone, would you please give us your new address. The speech recognition will receive the new address from the user, confirm it and write it to the database and then they will be able to hang up.

In certain embodiments, the system is equipped with a Geospatial engine which is commonly called a mapping tool. The mapping tool allows other features and functions to be added to the system, such as look-ahead conferencing where a particular person may be in need of help in a jurisdiction that they are heading toward so that both PSAPs can conference and decide what the best response would be when the caller crosses a particular jurisdictional line.

In addition, because embodiments of the system may be implemented to have a full-blown Geospatial engine, the system is able to accommodate 3-dimensional drawings of buildings and when the industry provides a Z coordinate, the system is able to locate a particular caller in the 3-dimensional drawing of the given building and provide that information to the PSAPs in a format such as 2200 Ross Boulevard, 28^{th} Floor, left-hand corner. The system is available and can accommodate that at the moment, if anyone can provide the information. Should this “Z” information be available, the system will be able to use it accordingly. Private industry will also be able to use it for VOIP PBXs and VOIP Citrix since the system has database capabilities to include information about the particular telephone users such as health conditions, what cubicle they might be located in, or even (should private industry want to do it) that particular person's calendar for the day. All of this information can be made available in the system's database, and in certain embodiments of the system the database already accommodates room for that additional information. One question that may need to be addressed for any such additional information is what will the formats be of the PSAPs receiving the data and will privacy acts allows the system to transmit it.

Another feature that may be included according to certain embodiments is the Important Party Joint Notification Feature. This will allow the system 10 to call any designated party should any other designated party dial 911. So for instance, if a spouse were to dial 911, the other spouse would be notified and the system would tell them that 911 had been called by their spouse and that it had been reported to the appropriate public responder. Additionally, a conference feature may be included wherein that spouse will be able to dial the 911 center and conference with the call taking place with their spouse.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for providing emergency call routing, said system comprising:
database for coordinating current physical location of a caller with a geographically sensitive called party; and
a matching circuit for matching an incoming call from a caller currently located at a particular location with a proper called party based upon said geographically sensitive matching data, when said caller has called an emergency calling number.

2. The system of claim 1 wherein said emergency calling number is 911.

3. The system of claim 1 wherein said proper called party comprises a proper Public Safety Answering Point (PSAP).

4. The system of claim 3 wherein said proper PSAP comprises a PSAP that is designated for servicing said caller's current physical location.

5. The system of claim 1 further comprising:
routing circuit for routing said caller to said proper called party.

6. The system of claim 1 wherein said matching circuit comprises:
a geospatial coordinate generator for determining a geospatial coordinate for the current physical location of the caller; and
identifying logic for identifying said proper called party to which the caller is to be routed based upon said determined geospatial coordinate.

7. The system of claim 6 wherein said geospatial coordinate generator determines the geospatial coordinate based at least in part on an automatic number identification (ANI) determined for the call.

8. The system of claim 6 further comprising: formatting logic for formatting information into a format desired for the identified proper called party.

9. The system of claim 8 wherein said information comprises the determined geospatial coordinate.

10. The system of claim 8 wherein said information comprises information pre-stored in said database about said caller.

11. The system of claim 6 wherein said geospatial coordinate comprises an XY coordinate.

12. The system of claim 6 wherein said geospatial coordinate comprises an XYZ coordinate.

13. A method for call routing, said method comprising:
receiving an emergency call from a calling party, said call identified by said calling party dialing a universally known calling number;
determining a present physical location of said calling party, said determining based upon a knowledge of physical coordinates of said calling party; and
completing said emergency call to a service center pre-identified as serving said present physical location based upon said determined present physical location of said calling party.

14. The method of claim 13 wherein said universally known calling number is 911.

15. The method of claim 13 wherein said determining comprises:
determining a geospatial coordinate for the present physical location of the calling party.

16. The method of claim 15 further comprising:
identifying said service center to which the calling party is to be routed based upon said determined geospatial coordinate.

17. The method of claim 15 wherein said determining said geospatial coordinate comprises:
determining the geospatial coordinate based at least in part on an automatic number identification (ANI) determined for the received emergency call.

18. The system of claim 15 wherein said geospatial coordinate comprises an XY coordinate.

19. The method of claim 15 wherein said geospatial coordinate comprises an XYZ coordinate.

20. The method of claim 13 further comprising:
formatting information into a format desired for the service center pre-identified as serving said present physical location.

21. The method of claim 20 wherein said information comprises a determined geospatial coordinate.

22. A system for emergency call routing, said system comprising:
an interface for receiving an emergency call placed by a caller;
a geospatial coordinate generator for determining a geospatial coordinate for the location of the caller; and
identifying logic for identifying a proper Public Safety Answering Point (PSAP) to which the emergency call is to be routed based upon said determined geospatial coordinate.

23. The system of claim 22 further comprising:
formatting logic for formatting information into a format desired for the identified PSAP.

24. The system of claim 23 wherein said information comprises the determined geospatial coordinate.

25. The system of claim 23 wherein said information comprises information pre-stored in a database about said caller.

26. The system of claim 25 wherein said information pre-stored in the database about said caller comprises at least one of: a contact number for another party to be notified of the emergency call, and a calendar of the caller.

27. The system of claim 23 further comprising:
routing logic for routing said emergency call and said formatted information to said determined PSAP.

28. The system of claim 22 wherein said geospatial coordinate comprises an XY coordinate.

29. The system of claim 22 wherein said geospatial coordinate comprises an XYZ coordinate.

30. The system of claim 22 wherein said geospatial coordinate generator determines the geospatial coordinate based at least in part on an automatic number identification (ANI) determined for the emergency call.
